(19) United States
(12) Patent Application Publication
(10) Pub. No.: US 2007/0005320 A1
(43) Pub. Date: Jan. 4, 2007

(54) Model-based configuration management

(75) Inventors: Anders B. Vinberg, Kirkland, WA (US); Anand Lakshminarayanan, Redmond, WA (US); Ashvinkumar J. Sanghvi, Sammamish, WA (US); Vij Rajarajan, Issaquah, WA (US); Vitaly Voloshin, Issaquah, WA (US); Bassam Tabbara, Seattle, WA (US); Kevin Grealish, Seattle, WA (US); Rob Mensching, Redmond, WA (US); Geoffrey Outhred, Seattle, WA (US); Galen C. Hunt, Bellevue, WA (US); Aamer Hydrie, Seattle, WA (US); Robert V. Welland, Seattle, WA (US); Rajagopalan Badri Narayanan, Redmond, WA (US); Bruce W. Copeland, Redmond, WA (US); Ken Pan, Redmond, WA (US); David C. James, Bothell, WA (US); Michael J. Healy, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/170,092

(22) Filed: Jun. 29, 2005

(51) Int. Cl. G06F 17/50

(52) U.S. Cl. 703/13

(57) ABSTRACT

Model-based configuration management and modeling identifies violations of configuration constraints. A system includes multiple components and multiple applications defined by a model of the system. A process identifies configuration settings associated with the components and configuration settings associated with the applications. A configuration policy is created for the system based on information contained in the model of the system and the configuration settings.

### BACKGROUND

Computers have become increasingly commonplace in our world and offer a variety of different functionality. Some computers are designed primarily for individual use, while others are designed primarily to be accessed by multiple users and/or multiple other computers concurrently. These different functionalities are realized by the use of different hardware components as well as different software applications that are installed on the computers.

Although the variety of available computer functionality and software applications is a tremendous benefit to the end users of the computers, such a wide variety can be problematic for the developers of the software applications as well as system administrators that are tasked with keeping computers running. Many computing systems contain a large number of different components that must work together and function properly for the entire computing system to operate properly. The demands on a computing system vary depending on one or more factors, such as the number of users accessing the computing system, the number of applications running on the computing system, the number of tasks or operations being performed by the computing system, and the capacities of various components in the computing system. System administrators need to configure and equip computing systems to handle current processing loads and, at times, may need to re-configure or plan for future processing requirements (e.g., due to additional users, increased numbers of tasks or operations being performed, and the like).

To assist system administrators with managing computer systems, it would be beneficial to provide a mechanism for managing and monitoring the configuration of various components in a computing system.

### SUMMARY

Model-based configuration management is described herein. A model of a system describes multiple components and multiple applications in the system. Configuration settings associated with the multiple components and the multiple applications are identified along with other targeting and scheduling parameters. A system configuration policy is generated based on the information contained in the model of the system and the configuration settings. The configuration of the components and applications in the system are then monitored for compliance with the configuration policy. The configuration policy can be applied to the components and applications, and compliance with the configuration policy can be enforced.

### BRIEF DESCRIPTION OF THE DRAWINGS

The same numbers are used throughout the drawings to reference like features.

FIG. 1 illustrates an example system definition model (SDM) that can be used with the model-based configuration management described herein.

FIG. 2 illustrates an example use of types, configurations, and instances.

FIG. 3 is a flowchart illustrating an example process for managing and monitoring the configuration of a system.

FIG. 4 is a flowchart illustrating an example process for creating a configuration policy associated with the system.

FIG. 5 illustrates an example general computer environment, which can be used to implement the techniques described herein.

### DETAILED DESCRIPTION

Model-based configuration management is described herein. Using the systems and methods described, a user, such as a system administrator, can manage the desired configuration of a system and can be notified when a configuration setting violates a constraint or configuration policy associated with the configuration setting. Changes to configuration settings happen regularly, such as when users modify their own workstations or install new software, when operators modify a machine to meet a new requirement or to troubleshoot a system. The systems and methods described herein allow an administrator to monitor configuration settings and identify potential problems with various configuration changes. The systems and methods described herein also apply configuration settings to existing systems, take corrective action when a system is out of compliance, and enforce a configuration by preventing non-compliant changes from being implemented.

As used herein, an application refers to a collection of instructions that can be executed by a processor, such as a central processing unit (CPU) of a computing device. An application can be any of a variety of different types of software or firmware, or portions thereof. Examples of applications include programs that run on an operating system, the operating system, operating system components, services, infrastructure, middleware, portions of any of these, and so forth.

Configuration policies are defined in terms of a model (e.g., a system definition model as discussed herein) that represents the structure and topology of the entire system. Defining configuration policies in terms of a model allows the configuration policies to easily adapt to changes in the system configuration. Additionally, the systems and methods discussed herein represent the hosting relationship between, for example, a SQL Server and the Windows® operating system, and then specify a constraint that flows across that relationship. This relationship allows the system to determine and maintain applicability and handle conflicts. However, the configuration policy for the SQL Server does not refer to internal details of the Windows® operating system. Thus, the relationship reduces the impact on the SQL Server policies when the Windows® operating system is modified. The systems and methods discussed herein further provide for the reconciliation of multiple conflicting policies. For example, the SQL Server and other applications may have different policies on how the Windows® operating system should be configured. The described systems and methods resolve any differences in these policies when it is possible to do so by finding compromise settings that are compliant with all the policies. When such a resolution is not possible, the unresolvable conflict is identified and brought to the attention of a user, such as an administrator, who can handle the problem on a higher level, for example by deploying the applications on other computer systems where there is no conflict.

A system definition model (SDM) describes a system that can be managed. Management of a system can include, for example, installing software on the system, monitoring the performance of the system, maintaining configuration information about the system, verifying that constraints within the system are satisfied, combinations thereof, and so forth. A system can be, for example, an application, a single computing device, multiple computing devices networked together (e.g., via a private or personal network such as a local area network (LAN) or via a larger network such as the Internet), and so forth.

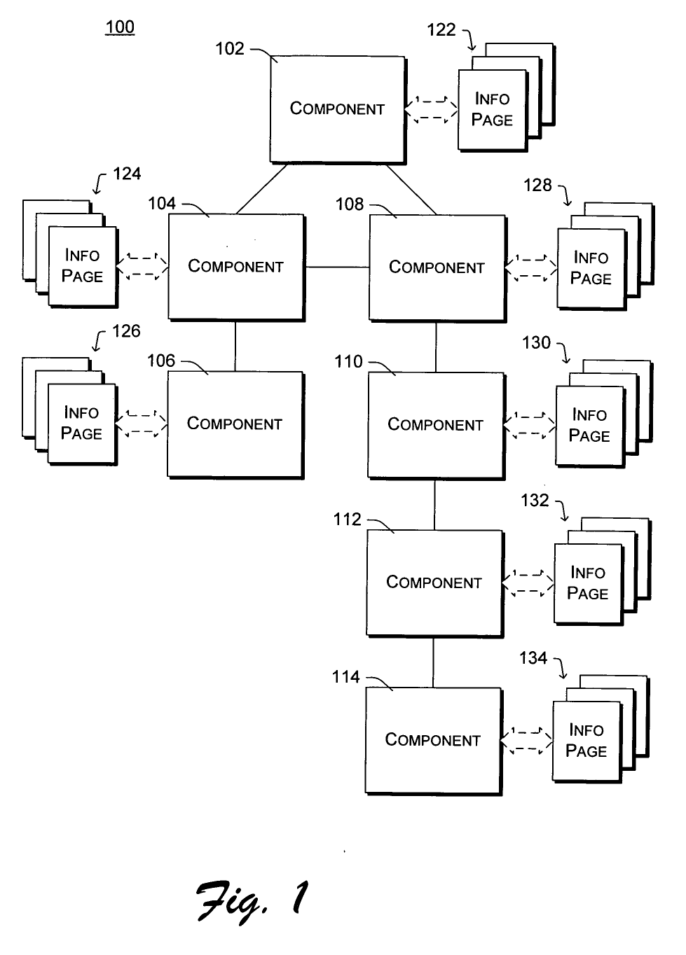

FIG. 1 illustrates an example SDM 100 that can be used with the model-based configuration management described herein. SDM 100 includes a component corresponding to each software and/or hardware component in a system. Examples of hardware and/or software components that could be in a system include an application (such as a database application, email application, file server application, game, productivity application, operating system (and its subsystems and components such as networking and storage), and so forth), particular hardware on a computer (such as a network card, a hard disk drive, one of multiple processors, and so forth), a virtual machine, a computer, a group of multiple computers, and so on. A system refers to a collection of one or more hardware and/or software components.

SDM 100 represents a system including component 102, component 104, component 106, component 108, component 110, component 112, and component 114. Although the example SDM 100 includes seven components, in practice a system, and thus the SDM, can include any number of components. Each hardware or software component being managed in a system is represented by a component in SDM 100.

For example, component 106 could represent a particular computer, while component 104 represents an operating system running on that particular computer. By way of another example, component 106 could represent an operating system, while component 104 represents a database application running on the operating system. By way of yet another example, component 114 could represent a particular computer, while component 112 represents an operating system installed on that particular computer, component 110 represents a virtual machine running on the operating system, and component 108 represents an operating system running on the virtual machine. Note that the operating systems associated with component 112 and component 108 could be the same or alternatively two different operating systems.

The SDM is intended to be a comprehensive knowledge store, containing all information used in managing the system. This information includes information regarding the particular components in the system, as well as relationships among the various components in the system. Despite this intent, it is to be appreciated that the SDM may contain only some of the information used in managing the system rather than all of the information.

Relationships can exist between different components in a system, and these relationships are illustrated in the SDM diagram with lines connecting the related components. Examples of relationships that can exist between components include containment relationships, hosting relationships, and communication relationships. Containment relationships identify one component as being contained by another component—data and definitions of the component being contained are incorporated into the containing component. When one component is contained by another component, that other component can control the lifetime of the contained component, can control the visibility of the contained component, and can delegate behavior to the contained component. In FIG. 1, containment relationships are illustrated by the diagonal lines connecting component 102 and component 104, and connecting component 102 and component 108.

Hosting relationships identify dependencies among components. In a hosting relationship, the hosting component should be present in order for the guest component to be included in the system. In FIG. 1, hosting relationships are illustrated by the vertical lines connecting component 104 and component 106, connecting component 108 and component 110, connecting component 110 and 112, and connecting component 112 and 114.

Communication relationships identify components that can communicate with one another. In FIG. 1, communication relationships are illustrated by the horizontal line connecting component 104 and component 108.

Associated with each component in SDM 100 is one or more information pages. Information pages 122 are associated with component 102, information pages 124 are associated with component 104, information pages 126 are associated with component 106, information pages 128 are associated with component 108, information pages 130 are associated with component 110, information pages 132 are associated with component 112, and information pages 134 are associated with component 114. Each information page contains information about the associated component. Different types of information can be maintained for different components. In certain embodiments, different pages contain different types of information, such as one page containing installation information and another page containing constraint information. Alternatively, different types of information may be included on the same page, such as installation information and constraint information being included on the same page.

Examples of types of information pages include installation pages, constraint pages, monitoring pages, service level agreement pages, description pages, and so forth. Installation pages include information describing how to install the associated component onto another component (e.g., install an application onto a computer), such as what files to copy onto a hard drive, what system settings need to be added or changed (such as data to include in an operating system registry), what configuration programs to run after files are copied onto the hard drive, and so forth.

Constraint pages include information describing constraints for the associated component, including constraints to be imposed on the associated component, as well as constraints to be imposed on the system in which the associated component is being used (or is to be used). Constraints imposed on the associated component are settings that the component should have (or alternatively should not have) when the component is installed into a system. Constraints imposed on the system are settings that the system should have (or alternatively should not have) in order for the associated component to be used in that particular system. Constraint pages may also optionally include default values for at least some of these settings, identifying a default value to use within a range of values that satisfy the constraint. These default values can be used to assist in installation of an application, as discussed in more detail below.

Monitoring pages include information related to monitoring the performance and/or health of the associated component. This information can include rules describing how the associated component is to be monitored (e.g., what events or other criteria to look for when monitoring the component), as well as what actions to take when a particular rule is satisfied (e.g., record certain settings or what events occurred, sound an alarm, etc.).

Service level agreement pages include information describing agreements between two or more parties regarding the associated component (e.g., between the purchaser of the associated component and the seller from which the associated component was purchased). These can be accessed during operation of the system to determine, for example, whether the agreement reached between the two or more parties is being met by the parties.

Description pages include information describing the associated component, such as various settings for the component, or other characteristics of the component. These settings or characteristics can include a name or other identifier of the component, the manufacturer of the component, when the component was installed or manufactured, performance characteristics of the component, and so forth. For example, a description page associated with a component that represents a computing device may include information about the amount of memory installed in the computing device, a description page associated with a component that represents a processor may include information about the speed of the processor, a description page associated with a component that represents a hard drive may include information about the storage capacity of the hard drive and the speed of the hard drive, and so forth.

As can be seen in FIG. 1, an SDM maintains various information (e.g., installation, constraints, monitoring, etc.) regarding each component in the system. Despite the varied nature of these information pages, they are maintained together in the SDM and thus can all be readily accessed by various utilities or other applications involved in the management of the system.

An SDM can be generated and stored in any of a variety of different ways and using any of a variety of different data structures. In certain embodiments, the SDM is based on a data structure format including types, instances, and optionally configurations. Each component in the SDM corresponds to or is associated with a type, an instance, and possibly one or more configurations. Additionally, each type, instance, and configuration corresponding to a particular component can have its own information page(s). A type refers to a general template having corresponding information pages that describe the component generally. Typically, each different version of a component will correspond to its own type (e.g., version 1.0 of a software component would correspond to one type, while version 1.1 of that software component would correspond to another type). A configuration refers to a more specific template that can include more specific information for a particular class of the type. An instance refers to a specific occurrence of a type or configuration, and corresponds to an actual physical component (software, hardware, firmware, etc.).

For types, configurations, and instances associated with a component, information contained in information pages associated with an instance can be more specific or restrictive than, but cannot contradict or be broader than, the information contained in information pages associated with the type or the configuration. Similarly, information contained in information pages associated with a configuration can be more specific or restrictive than, but cannot contradict or be broader than, the information contained in information pages associated with the type. For example, if a constraint page associated with a type defines a range of values for a buffer size, the constraint page associated with the configuration or the instance could define a smaller range of values within that range of values, but could not define a range that exceeds that range of values.

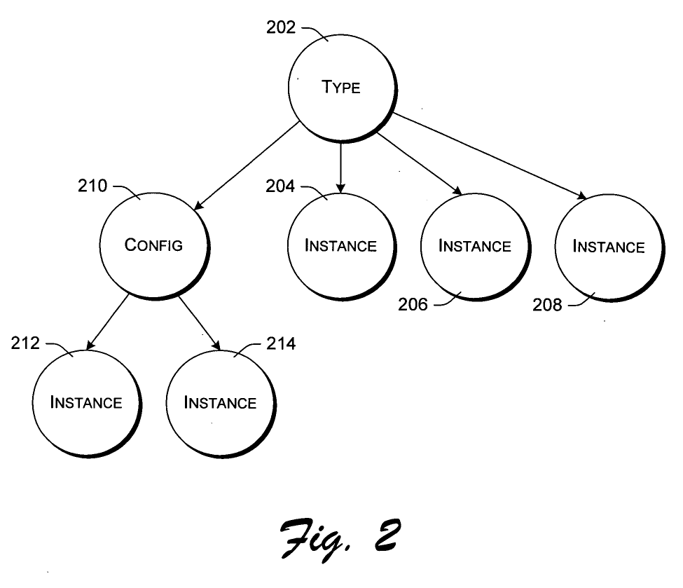

The use of types, configurations, and instances is illustrated in FIG. 2. In FIG. 2, a type 202 corresponds to a particular component. Three different instances 204, 206, and 208 of that particular component exist and are based on type 202. Additionally, a configuration (config) 210 exists which includes additional information for a particular class of the particular component, and two instances 212 and 214 of that particular class of the particular component.

For example, assume that a particular component is a database application. A type 202 corresponding to the database application is created, having an associated constraint information page. The constraint information page includes various general constraints for the database application. For example, one of the constraints may be a range of values that a particular buffer size should be within for the database application. Type 202 corresponds to the database application in general.

Each of the instances 204, 206, and 208 corresponds to a different example of the database application. Each of the instances 204, 206, and 208 is an actual database application product, and can have its own associated information pages. For example, each instance could have its own associated description information page that could include a unique identifier of the particular associated database application product. By way of another example, the constraint information page associated with each instance could include a smaller range of values for the buffer size than is indicated in the constraint information page associated with type 202.

The information pages corresponding to the instances in FIG. 2 can be in addition to, or alternatively in place of, the information pages corresponding to the type. For example, two constraint information pages may be associated with each instance 204, 206, and 208, the first constraint information page being a copy of the constraint information page associated with type 202 and the second constraint information page being the constraint information page associated with the particular instance and including constraints for just that instance. Alternatively, a single constraint information page may be associated with each instance 204, 206, and 208, the single constraint information page including the information from the constraint information page associated with type 202 as well as information specific to the particular instance. For example, the range of values that the particular buffer size should be within for the database application would be copied from the constraint information page associated with type 202 to the constraint information page associated with each instance. However, if the constraint information page for the instance indicated a different range of values for that particular buffer size, then that different range of values would remain in the constraint information page associated with the instance rather than copying the range of values from the constraint information page associated with type 202.

Following this example of a database application, configuration 210 corresponds to a particular class of the database application. For example, different classes of the database application may be defined based on the type of hardware the application is to be installed on, such as different settings based on whether the computer on which the database application is to be installed is publicly accessible (e.g., accessible via the Internet), or based on whether an operating system is already installed on the server. These different settings are included in the constraint information page associated with configuration 210.

Each of the instances 212 and 214 corresponds to a different example of the database application. Similar to instances 204, 206, and 208, each of instances 212 and 214 is an actual database application product, and can have its own information page(s). However, unlike instances 204, 206, and 208, the constraint information pages associated with instances 212 and 214 each include the constraints that are in the constraint information page associated with configuration 210 as well as the constraints in the constraint information page associated with type 202.

It should be noted that, although the information pages are discussed as being separate from the components in the SDM, the data structure(s) implementing the SDM could alternatively include the information discussed as being included in the various information pages. Thus, the component data structures themselves could include the information discussed as being included in the various information pages rather than having separate information pages.

The installation page associated with a component can be used as a basis for provisioning a system. Provisioning a system refers to installing an application(s) on the system, as well as making any necessary changes to the system in order for the application(s) to be installed. Such necessary changes can include, for example, installing an operating system, installing one or more other applications, setting configuration values for the application or operating system, and so forth.

In the discussions herein, reference is made to different classes of computing devices. Each of these different classes of computing devices refers to computing devices having particular common characteristics, so they are grouped together and viewed as a class of devices. Examples of different classes of devices include IIS (Internet Information Services) servers that are accessible to the Internet, IIS servers that are accessible only on an internal intranet, database servers, email servers, order processing servers, desktop computers, and so forth. Typically, each different class of computing device corresponds to one of the configurations in the system model.

The SDM contains static information (e.g., the topology of software services within an application) and dynamic information (e.g., the control flow of a particular transaction). This information is used to describe components, system architecture, and transaction flows (e.g., a series of steps that perform a function).

As mentioned above, configuration management is important to allow an administrator to monitor configuration settings and identify potential problems with various configuration changes. The systems and methods discussed herein validate the compliance of systems (and components) with a prescribed configuration and report any violations of this prescribed configuration. The prescribed configuration may represent a secure configuration, thereby minimizing vulnerability to attack, or it may represent a configuration desired by an IT (Information Technology) department to maintain consistency and reduce support costs. Information contained in the SDM is used to provide a context for the configuration settings, such as the components or applications with which the settings are associated and the relationships between the components and applications in the system.

The systems and methods described herein inspect the configuration of one or more components or systems, and compare the configuration(s) with the prescribed configuration policy. Different configuration policies can be associated with different components or systems based on, for example, organizational groups or departments, geography, type of component or system, and the like.

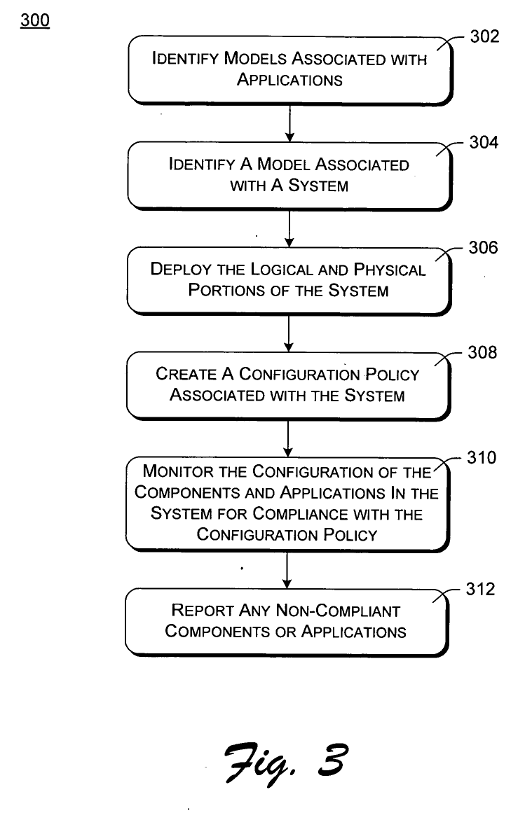

FIG. 3 is a flowchart illustrating an example process 300 for managing and monitoring the configuration of a system. Process 300 can be implemented in software, firmware, and/or hardware. Initially, process 300 identifies models associated with one or more applications (block 302). An application model can identify any number of configuration settings or constraints associated with the application. In one embodiment, the configuration settings or constraints are defined by a developer of the application. Example configuration settings include buffer sizes, acceptable data formats, acceptable application or operating system versions, and a setting indicating whether a firewall is activated. Constraint information can be contained in, for example, a constraint page of the type discussed above with respect to the SDM. Process 300 continues by identifying a model associated with the system (block 304). In one embodiment, this model is an SDM model of the type discussed above with respect to FIGS. 1 and 2.

After identifying one or more application models and a system model, the process deploys the logical and physical portions of the system (block 306). This deployment of the system “activates” the system and defines interrelationships between the various components and applications in the system. Although it is common that the process includes deployment of the system based on the model, in certain embodiments the system may be deployed in other ways, with or without reference to the model. Such deployment may have occurred well before the model-based configuration management process is started, and before the model was created. In these embodiments, block 306 may be omitted from the process.

The process continues by creating a configuration policy associated with the system (block 308). In a particular embodiment, the configuration policy is created automatically based on the system model and the configuration settings associated with the components and the applications. A system may have configuration constraints or dependencies on related systems. For example, if a particular application is installed in the system, it may have a dependency on another system and may require a specific configuration setting on that other system. A “dependency” is also referred to as a “relationship.”

In one embodiment, the process extracts the desired information from the system model and discards the remaining information contained in the system model. The system model structure is then flattened to create configuration settings for each component in the system. These configuration settings are then saved in a simplified schema that is consistent with the full system model.

The process continues by monitoring the configuration of the components and applications in the system for compliance with the configuration policy (block 310). An administrator or other user typically defines the frequency with which the components and applications are checked for compliance. This compliance checking may occur at any interval, such as every 10 minutes, every hour, every day, or every week. In particular embodiments, different components or applications are checked for compliance at different intervals. For example, critical components or applications are checked once every 10 minutes while less critical components or applications are checked once every two hours.

If any component or application is not in compliance with the configuration policy, the process generates an alert or a report identifying the non-compliance (block 312). The alert or report may be, for example, an email message, a pager message, a cell phone message, an audible alarm, or a pop-up message on a computer monitor. Additionally, information regarding the alert or report may be recorded in a daily log with other alerts and activities.

Based on information contained in alerts or reports, various types of corrective actions can be taken. For example, a management system operating on the managed computer system can immediately correct a configuration setting when it detects the configuration setting is out of compliance with an associated configuration policy. In another example, a central management system can respond to an alert by starting a process to bring the system into compliance. Additionally, a central management system can add the system that is found to be out of compliance to a list of systems that is later used as a target for various management systems. In any of these examples, the corrective action can use techniques such as changing a configuration setting, installing a software system, removing a software system, or running a program that performs an operation such as moving information off a storage device.

A management system can also enforce a configuration policy by preventing changes from being made that would result in a configuration that is out of compliance. The intended setting is compared with the configuration policy, and if it would result in a compliance violation, the change is rejected and an error message is returned. To reliably enforce a change, the management system intercepts the change before it is applied to the system. Additionally, the management system can operate in an advisory mode, where an application can choose to consult the management system. For example, the application may ask if the intended change would be in compliance with the configuration policies. If the intended change would not be in compliance with the configuration policies, the application can choose not to make the change.

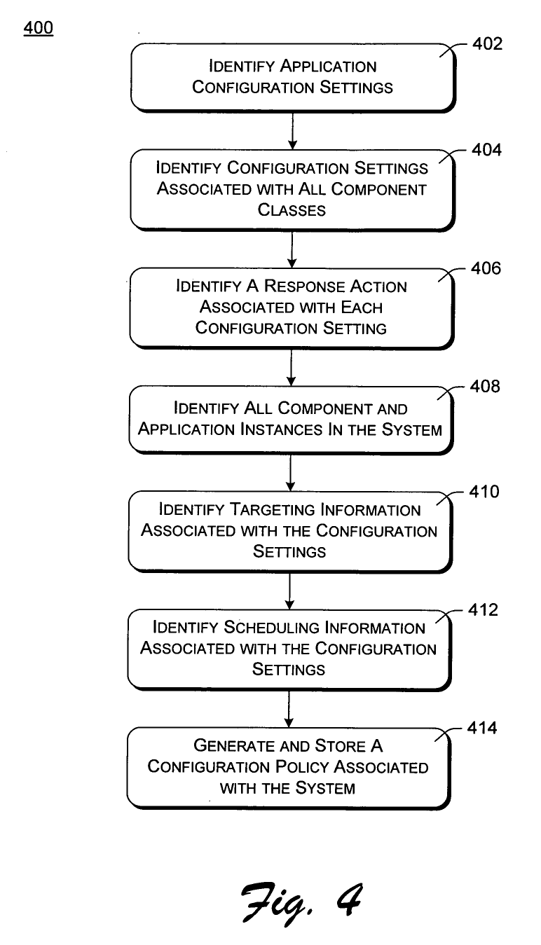

FIG. 4 is a flowchart illustrating an example process 400 for creating a configuration policy associated with the system. Initially, process 400 identifies application configuration settings (block 402). For example, a particular application may have a dependency on another system and may require a specific configuration setting to properly interact with the other system. The process continues by identifying configuration settings associated with all component classes (block 404). Component classes may include classes of machines, groups of machines, and the like. A particular component class may contain any number of component instances.

Next, process 400 identifies a response action associated with each configuration setting (block 406). The response action identifies an action to take in response to identifying a violation of a configuration constraint. Example response actions include generating a report, activating an alarm, sending an alert message to an administrator, logging a violation in a daily log, halting operation of a component or application, resetting a component, or restarting an application. A configuration constraint defines the allowable value(s) or a range of values that are permitted for a particular configuration setting. The process continues by identifying all component and application instances in the system (block 408). In one embodiment, component and application instances are identified from the system model.

Process 400 then identifies targeting information associated with one or more configuration settings (block 410). Targeting information identifies particular components or particular applications, or may identify groups of components and/or groups of applications. For example, a group of components may include all components of a particular type, all components in a particular geographic region, or all components in a particular department of an organization. The process continues by identifying scheduling information associated with one or more configuration settings (block 412). Scheduling information determines the frequency with which certain configuration settings are checked for compliance with their associated constraints. As discussed above, some configuration settings may be checked for compliance more frequently than others.

Finally, process 400 generates and stores a configuration policy associated with the system (block 414). This configuration policy includes constraints associated with all components and applications in the system as well as information regarding response actions, targeting information, and scheduling information associated with the system. In certain implementations, an administrator or other user can modify the configuration policy to meet their desires or operating requirements. The configuration policy can specify, for each constraint, what the corrective action should be (if any), or specify that only a report or alert should be created.

In one embodiment, the identification of components and applications is performed automatically based on information contained in the system model. However, the identification of target information and the identification of scheduling information is determined by an administrator or other user.

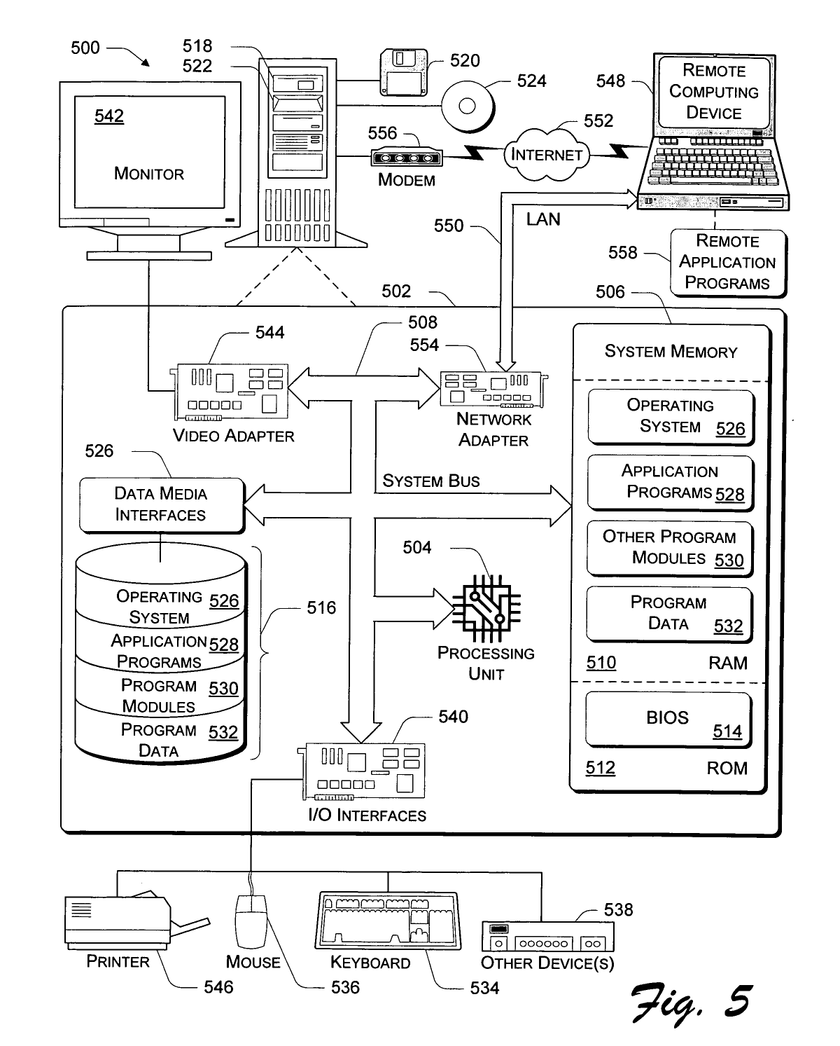

FIG. 5 illustrates an example general computer environment 500, which can be used to implement the techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing device in the form of a computer 502. Computer 502 can be, for example, a desktop computer, a handheld computer, a notebook or laptop computer, a server computer, a game console, and so on. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus; a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternatively, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing device 548. By way of example, the remote computing device 548 can be a personal computer, portable computer, a server, a router, a network computer, a peer device or other common network node, and the like. The remote computing device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Alternatively, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
identifying a model of a system that includes a plurality of components and a plurality of applications;
identifying configuration settings associated with the plurality of components;
identifying configuration settings associated with the plurality of applications; and
creating a configuration policy associated with the system, wherein the configuration policy is defined based on information contained in the model of the system and the configuration settings.

2. A method as recited in claim 1, wherein identifying configuration settings associated with the plurality of components includes identifying at least one constraint on the configuration settings associated with the plurality of components.

3. A method as recited in claim 1, wherein identifying configuration settings associated with the plurality of applications includes identifying at least one constraint on the configuration settings associated with the plurality of applications.

4. A method as recited in claim 1, wherein the model of the system identifies a relationship between at least two components of the system.

5. A method as recited in claim 1, wherein the model of the system identifies a relationship between at least one application and at least one component of the system.

6. A method as recited in claim 1, wherein creating a configuration policy associated with the system includes:
identifying a response action associated with the configuration settings;
identifying targeting information associated with the configuration settings; and
identifying scheduling information associated with the configuration settings.

7. A method as recited in claim 6, wherein the targeting information identifies a group of components that receive the same configuration settings.

8. A method as recited in claim 1, wherein identifying configuration settings associated with each of the plurality of components includes accessing a description page in the model of the system, wherein the description page is associated with at least one component of the system and identifies relationships with other components in the system.

9. A method as recited in claim 1, further comprising monitoring configuration of the components and applications for compliance with the configuration policy.

10. A method as recited in claim 9, further comprising reporting any non-compliant components or applications.

11. A method as recited in claim 1, wherein the model of the system defines the topology of the entire system.

12. A method comprising:
identifying a model of a system that describes a plurality of components in the system;
identifying configuration settings associated with the plurality of components;
identifying a response action associated with the configuration settings;
identifying targeting information associated with the configuration settings; and
creating a configuration policy associated with the system, wherein the configuration policy is defined using information contained in the model of the system, the configuration settings, the response action, and the targeting information.

13. A method as recited in claim 12, wherein the model of the system further describes a plurality of applications.

14. A method as recited in claim 13, further comprising identifying configuration settings associated with the plurality of applications.

15. A method as recited in claim 13, wherein the configuration policy is further based on the configuration settings associated with the plurality of applications.

16. A method as recited in claim 12, wherein the model of the system further describes relationships between the plurality of components.

17. One or more computer readable media having stored thereon a plurality of instructions that, when executed by one or more processors, causes the one or more processors to:
identify a plurality of components in a system;
identify a plurality of applications in the system;
identify a plurality of component configuration settings;
identify a plurality of application configuration settings;
identify relationships between the plurality of components and the plurality of applications;
create a configuration policy defined by the component configuration settings, the application configuration settings, and the relationships between the plurality of components and the plurality of applications; and
monitor configuration of the components and the applications for compliance with the configuration policy.

18. One or more computer readable media as recited in claim 17, wherein the one or more processors further report any non-compliant components or applications.

19. One or more computer readable media as recited in claim 17, wherein the one or more processors further take a predetermined action in response to any non-compliant components or applications.

20. One or more computer readable media as recited in claim 17, wherein the system is defined by a model representative of the structure of the entire system.
